(19) United States
(12) Patent Application Publication
(10) Pub. No.: US 2015/0226362 A1
(43) Pub. Date: Aug. 13, 2015

(54) ELECTRICALLY HEATED HOSE

(71) Applicant: Graco Minnestoa Inc., Minneapolis, MN (US)

(72) Inventors: Mark J. Brudevold, Fridley, MN (US); Joshua D. Roden, Blaine, MN (US); Troy D. Jones, Brooklyn Center, MN (US); Roman S. Kopylov, Prior Lake, MN (US)

(21) Appl. No.: 14/422,935

(22) PCT Filed: Apr. 19, 2013
(86) PCT No.: PCT/US2013/037431

§ 371 Date: Feb. 20, 2015

Related U.S. Application Data
(60) Provisional application No. 61/635,917, filed on Apr. 20, 2012.

(51) Int. Cl. F16L 53/00; B32B 15/04; B32B 15/082; B32B 15/095; F16L 11/127; B32B 27/06; B32B 27/32; B32B 27/40; B32B 27/34; B32B 1/08; B32B 15/02

(52) U.S. Cl. CPC F16L 53/008; B32B 1/08; B32B 15/043; B32B 15/082; B32B 15/095; B32B 15/02; B32B 27/06; B32B 27/32; B32B 27/40; B32B 27/34; F16L 11/127; B32B 2255/06; B32B 2307/302; B32B 2307/7265; B32B 2597/00

(57) ABSTRACT

A heated fluid line comprises an inner tube, an outer sheath, and a heating element. The heating element disposed between the inner tube and the outer sheath. The heating element comprises an interior core formed of a first metallic material, and an exterior jacket formed of a second metallic material. In one embodiment, the heating element is wrapped around the inner tube and has a round cross-section. In another embodiment, the exterior jacket is non-reactive and resistant to water corrosion, and the outer sheath is moisture impermeable.

### CROSS-REFERENCE TO RELATED APPLICATION(S)

This application claims priority under 35 U.S.C. §119 to U.S. provisional application Ser. No. 61/635,917, entitled “ELECTRICALLY HEATED HOSE,” filed Apr. 20, 2012 by inventors Mark J. Brudevold, Joshua D. Roden, Troy D. Jones and Roman S. Kopylov, the contents of which are incorporated by this reference.

### BACKGROUND

The present disclosure relates generally to heated hoses, such as for use with plural-component dispensing systems. More particularly, the present disclosure relates to electrically heated flexible hoses.

Conventional electrically heated hoses are fabricated by wrapping a conductor around a flexible inner tube and then enshrouding the wrapped tube in a sheathing. Typically, the inner tube comprises a nylon core reinforced with a fiber or aramid braid, which is covered with a polyurethane sleeve. The inner tube is then wrapped with a conductive wire. The conductive wire typically comprises a flat copper wire that can either be a solid ribbon or braided strands. The flat wire enables the heated hose to have a smaller diameter and also increases the area of contact between the inner tube and the conductive wire. The sheathing typically comprises a butyl sleeve.

Heated hoses used in plural-component dispensing systems are subject to rigorous handling that results in operator fatigue and degraded performance of the electrically heated hose. For example, repeated back-and-forth motion of a dispenser gun used in conjunction with these systems becomes tiring if the hose is too stiff, and produces fatigue life failure of the conductor wire after a definite period of time. There is, therefore, a continuing need to increase the flexibility of electrically heated hoses to reduce operator fatigue, while at the same time increasing fatigue life of the hose to reduce component failure.

### SUMMARY

The present disclosure is directed to electrically heated hoses, such as for use with plural-component dispensing systems or hot melt adhesive dispensing systems. A heated fluid line comprises an inner tube, an outer sheath, and a heating element. The heating element is disposed between the inner tube and the outer sheath. The heating element comprises an interior core formed of a first metallic material, and an exterior jacket formed of a second metallic material. In one embodiment, the heating element is wrapped around the inner tube and has a round cross-section. In another embodiment, the exterior jacket is non-reactive and resistant to water corrosion, and the outer sheath is moisture impermeable.

### BRIEF DESCRIPTION OF THE DRAWINGS

FIG. 1 is a perspective view of a dual-component pump system having a pumping unit, component material containers and a dispensing gun connected to the pumping unit via electrically heated hoses.

FIG. 2 is a partially cut-away perspective view of an electrically heated hose of FIG. 1 comprising a core hose wrapped by a shielded heating element and covered by a sheath.

FIG. 3 is a schematic cross-sectional view of the electrically heated hose of FIG. 2 showing various layers of the core hose, the shielded heating element and the sheath.

### DETAILED DESCRIPTION

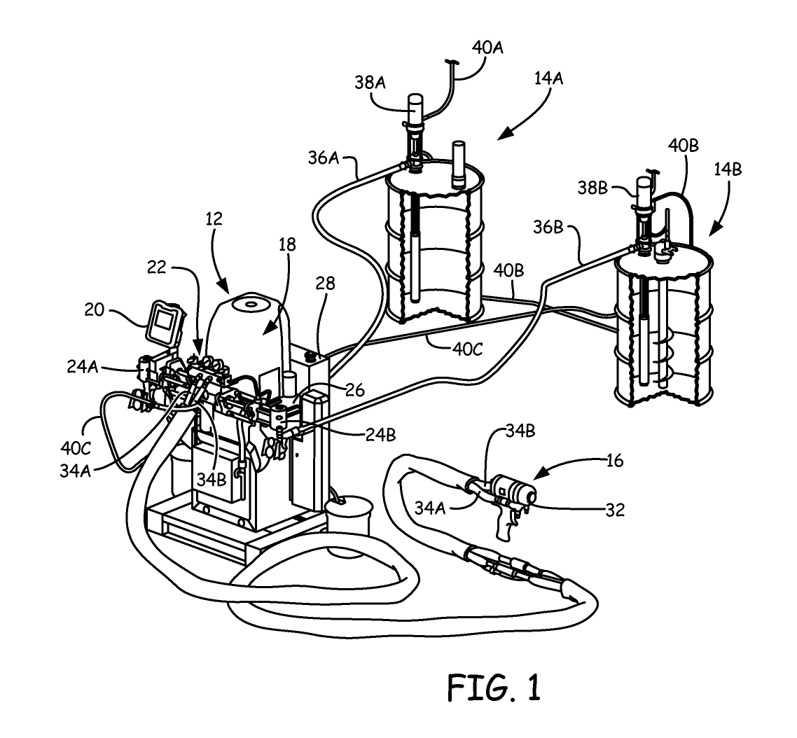

FIG. 1 is a perspective view of dual-component pump system 10 having pumping unit 12, component material containers 14A and 14B and dispensing gun 16. Pumping unit 12 comprises hydraulic power pack 18, display module 20, fluid manifold 22, first linear pump 24A, second linear pump 24B, hydraulic fluid reservoir 26 and power distribution box 28. As is known in the art, an electric motor, a dual output reversing valve, a hydraulic linear motor, a gear pump and a motor control module (MCM) for each of linear pumps 24A and 24B are located within hydraulic power pack 18. Dispensing gun 16 includes dispense head 32 and is connected to first linear pump 24A and second linear pump 24B by electrically heated hoses 34A and 34B, respectively. Hoses 36A and 36B connect feed pumps 38A and 38B to linear pumps 24A and 24B, respectively. Compressed air is supplied to feed pumps 38A and 38B and dispensing gun 16 through hoses 40A, 40B and 40C, respectively. Although described with respect to a dual-component dispensing system, the electrically heated hoses of the present disclosure may also be used with other types of dispensing systems, such as hot melt adhesive systems.

Component material containers 14A and 14B comprise drums of first and second viscous materials that, upon mixing, form a hardened structure. For example, a first component comprising a resin material, such as a polyester resin or a vinyl ester, is stored in component material container 14A, and a second component comprising a catalyst material that causes the resin material to harden, such as isocyanate or Methyl Ethyl Ketone Peroxide (MEKP), is stored in component material container 14B. Electrical power is supplied to power distribution box 28, which then distributes power to various components of dual-component system 10, such as the MCM within hydraulic power pack 18, display module 20 and electrically heated hoses 34A and 34B. Compressed air from a separate source (not shown) is supplied to feed pumps 36A and 36B through hoses 40A and 40B to supply flows of the first and second component materials to linear pumps 24A and 24B, respectively. Linear pumps 24A and 24B are hydraulically operated by the gear pump in hydraulic power pack 18. The gear pump is operated by the electric motor in power pack 18 to draw hydraulic fluid from hydraulic fluid reservoir 26 and provide pressurized hydraulic fluid flow to the dual output reversing valve, which operates the linear motor.

When a user operates dispense gun 16, pressurized component materials supplied to manifold 22 by linear pump 24A and linear pump 24B are forced to mixing head 32. Mixing head 32 blends the first and second component materials to begin the solidification process, which completes when the mixed component materials are sprayed into a mold, for example. The first and second component materials are typically dispensed from gun 16 at a constant output condition. For example, a user can provide an input at display module 20 to control the MCM to dispense the component materials at a constant pressure or at a constant flow rate.

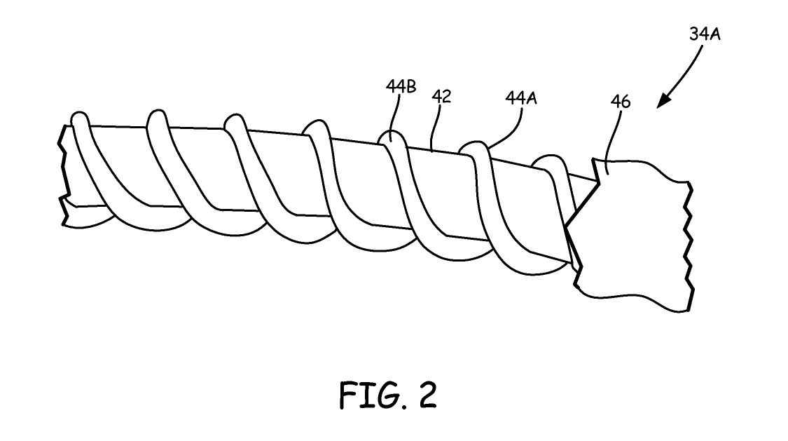

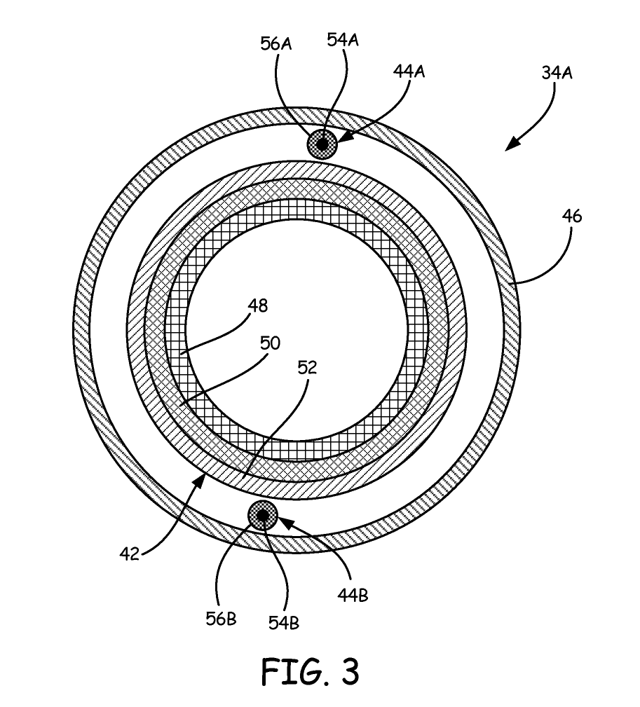

In order to ensure proper setting of the resin material and the catalyst material, hoses 34A and 34B are heated. In particular, hoses 34A and 34B include conductive wires that are provided with electrical power, such as from distribution box 28 or a standalone transformer box, to provide resistive heating to the hoses. As discussed above, conventional heated hoses include copper conductors that have rectangular cross-sections. In one configuration, the rectangular conductor comprises a solid ribbon, which can be difficult to flex. In another embodiment, the rectangular conductor comprises braided copper wires, which is susceptible to corrosion. It has been discovered that braided copper wires are particularly susceptible to corrosion when sheathed within butyl sleeves that are fabricated from recycled materials. First, the recycled material includes impurities, such as sulfur, that are released in a gas when the butyl sleeve is heated. Second, the butyl sleeve forms a vapor barrier that seals the copper conductor within a corrosive sulfuric environment. Lastly, the increased surface area of the braided material increases the reaction between the sulfur and the copper, thereby exacerbating the corrosion. The heated hoses of the present disclosure include conductor wires that are both easy to flex and that are resistant to corrosion, as is explained with reference to FIGS. 2 and 3.

FIG. 2 is a partially cut-away perspective view of electrically heated hose 34A of FIG. 1 comprising core hose 42 wrapped by shielded heating elements 44A and 44B, and covered by sheath 46. Core hose 42 comprises a flexible hose that is suitable for conveying fluids. Sheath 46 surrounds core hose 42. Shielded heating elements 44A and 44B are disposed between core hose 42 and sheath 46. Shielded heating elements 44A and 44B comprise conductors that heat core hose 42 when electric current is applied to shielded heating elements 44A and 44B. In the described embodiment, two strands of shielded heating element are wrapped around core hose 42 in a double-helix fashion. In other embodiments, one or more strands of shielded heating element may be provided between core hose 42 and sheath 46, either as helixes or as linear strands. Sheath 46, which is partially cut-away in FIG. 2, provides protection from the environment in which electrically heated hose 34A is used.

Shielded heating elements 44A and 44B comprise jacketed wire having a circular cross-sectional area. This round form factor allows shielded heating elements 44A and 44B to more readily move with core hose 42 as compared to conductors having rectangular cross-sectional areas. Specifically, circular cross-sections provide less bending resistance than rectangular cross-sections. Thus, the shape of shielded heating elements 44A and 44B promotes flexibility of electrically heated hose 34A. Furthermore, the round form factor also increases the life of electrically heated hose 34A. Specifically, round wire has superior fatigue characteristics over rectangular wire due to having perfect symmetry about its center axis. In one configuration of electrically heated hose 34A, core hose 42 is sufficiently rigid to only permit shielded heating elements 44A and 44B to flex to angles where shielded heating elements 44A and 44B have a nearly infinite fatigue life. Thus, electrically heated hose 34A is less prone to failure.

Shielded heating elements 44A and 44B comprise resistive heating elements formed of two layers. More particularly, shielded heating elements 44A and 44B are comprised of an inner conductive layer (shown in FIG. 3) and an outer layer (shown in FIGS. 2 & 3) that is non-reactive. In one embodiment, shielded heating elements 44A and 44B are formed of two metallic layers, with the inner layer being highly conductive and the outer layer being resistant to corrosion, while also being conductive. In particular, the outer layer does not react with water. Furthermore, the outer layer forms a barrier that inhibits corrosion of the inner layer from gases that may be formed and trapped within sheath 46 during operation of electrically heated hose 34A.

FIG. 3 is a schematic cross-sectional view of electrically heated hose 34A of FIG. 2 showing various layers of core hose 42, shielded heating elements 44A and 44B and sheath 46. Core hose 42 comprises tube 48, reinforcing layer 50 and cover 52. Shielded heating element 44A comprises inner layer 54A and outer layer 56A. Shielded heating element 44B comprises inner layer 54B and outer layer 56B. FIG. 3 is not drawn to scale and various elements are exaggerated in size for illustrative purposes. FIG. 3 is described with reference to the construction of shielded heating element 44A, though, in the embodiment shown, shielded heating element 44B has a similar construction.

Core hose 42 comprises any suitable hose or tubing that can convey liquid at elevated temperatures and pressures. Thus, tube 48 typically comprises an impermeable material such as nylon, rubber or a polymer. However, because tube 48 is subject to elevated pressures, reinforcing layer 50 surrounds tube 48. Reinforcing layer 50 is itself flexible, but is configured to provide compressive force to tube 48 when under pressure. Reinforcing layer 50 has a maximum (un-stretched) diameter that is smaller than a stretched diameter of tube 48 to limit the amount that tube 48 can expand. In various embodiments, reinforcing layer 50 comprises braided strands of fiber or aramid, as is known in the art. Cover 52 comprises a flexible sleeve that surrounds reinforcing layer 50 that provides environmental isolation to reinforcing layer 50 and tube 48. Cover 52 is typically made of polyurethane. Core hose 42 can be, in various embodiments, a commercially available assembly.

Shielded heating element 44A is shown having a solid wire core around which a solid jacket is formed. Inner layer 54A comprises a single solid strand of a conductive material, while outer layer 56A comprises a single sleeve of a non-reactive material. As mentioned above, the single solid strand of circular wire increases the flexibility of electrically heated hose 34A. The single solid strand also reduces the corrosion susceptibility of shielded heating element 44A by reducing the overall surface area of the conductor as compared to braided strands.

Outer layer 56A further reduces the possibility of corrosion to inner layer 54A by isolating inner layer 54A from the environment inside sheath 46. Sheath 46 provides a moisture barrier that prevents water from coming into contact with shielded heating element 44A. Thus, in various embodiments, sheath 46 is moisture impermeable. This directly reduces the possibility of producing a corrosive environment inside sheath 46. However, as discussed above, sheath 46 may introduce corrosive gases into electrically heated hose 34A. In one embodiment, sheath 46 comprises a polyethylene jacket made from non-recycled materials, which reduces the amount of corrosive materials present within sheath 46 as compared to recycled butyl sleeves. Outer layer 56A prevents direct contact with sheath 46 and prevents contact from gases within sheath 46 that may have corrosive constituents.

Outer layer 56A is additionally a conductive material, which assists in producing resistive heating of shielded heating element 44A. Outer layer 56A does not function as an insulator that spaces the conductor from core hose 42. Thus, outer layer 56A increases the efficiency of shielded heating element 44A in heating core hose 42 as compared to non-conductive, insulating jackets. For example, some prior art electrically heated hoses utilize conductor wires that are jacketed in polymer sleeves that insulate and space the heating element conductor from the hose that is to be heated.

The electrically heated hose of the present disclosure is particularly useful in conjunction with plural-component dispensing or proportioning systems. These systems utilize a low voltage to produce current, such as 45 amps, in shielded heating element 44A to induce resistive heating. In such an embodiment, inner layer 54A comprises fourteen gage copper wire around which a thin layer of tin is disposed to form outer layer 56A. In other embodiments, outer layer 56A may be formed of silver or nickel. The electrically heated hose described herein may also be used with other types of dispensing systems, such as hot melt adhesive systems. Hot melt adhesive systems require the liquid hot melt, which may comprise a thermoplastic polymer glue such as ethylene vinyl acetate (EVA), to be heated to higher temperatures than the resin and catalyst of the plural-component dispensing systems. As such, a high voltage is applied to shielded heating element 44A in order to produce the desired amount of resistive heating. In such an embodiment, inner layer 54A may comprise copper, tin, iron or a nickel-chromium alloy, while outer layer 56A may comprise tin, silver or nickel.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heated fluid line comprising:
an inner tube;
an outer sheath; and
a heating element disposed between the inner tube and the outer sheath, the heating element comprising:
an interior core formed of a first metallic material; and
an exterior jacket formed of a second metallic material.

2. The heated fluid line of claim 1 wherein the heating element is wrapped around the inner tube.

3. The heated fluid line of claim 1 wherein the heating element has a circular cross-section.

4. The heated fluid line of claim 1 wherein the exterior jacket is resistant to water corrosion.

5. The heated fluid line of claim 1 wherein the outer sheath is moisture impermeable.

6. The heated fluid line of claim 1 wherein the outer sheath is formed of polyethylene.

7. The heated fluid line of claim 1 wherein the inner tube comprises:
a nylon hose;
a braided sheath surrounding the nylon hose; and
a polyurethane cover surrounding the braided sheath.

8. The heated fluid line of claim 1 wherein:
the interior core comprises copper wire; and
the exterior jacket comprises tin.

9. The heated fluid line of claim 1 wherein:
the interior core comprises copper wire; and
the exterior jacket comprises silver.

10. The heated fluid line of claim 1 wherein:
the interior core is selected from the group consisting of: tin, iron and nickel-chromium; and
the exterior jacket is selected from the group consisting of: tin, silver and nickel.

11. A heated fluid dispensing system comprising:
a first pump;
a drive system for actuating the first pump;
a heating system for heating material fed to an inlet of the first pump;
a gun for dispensing material from an outlet of the first pump; and
a first heated hose connecting the outlet of the first pump to the gun, the first heated hose comprising:
an inner core;
a metallic-coated conductor wrapped around the inner core; and
an outer sheath surrounding the metallic-coated conductor and the inner core.

12. The heated fluid dispensing system of claim 11 wherein the heating element has a round cross-section.

13. The heated fluid dispensing system of claim 11 wherein the outer sheath is moisture impermeable polyethylene.

14. The heated fluid dispensing system of claim 11 wherein the inner core comprises:
a flexible tube;
a braided reinforcing layer concentrically surrounding the flexible tube; and
a sleeve concentrically surrounding the braided reinforcing layer.

15. The heated fluid dispensing system of claim 11 wherein the metallic-coated conductor comprises:
a conductive center wire; and
an exterior jacket formed of a metal that is resistant to water corrosion.

16. The heated fluid dispensing system of claim 15 wherein:
the conductive center wire comprises copper; and
the exterior jacket is selected from the group consisting of tin, silver and nickel.

17. The heated fluid dispensing system of claim 15 wherein:
the conductive center wire is selected from the group consisting of: tin, iron and nickel-chromium; and
the exterior jacket is selected from the group consisting of: tin, silver and nickel.

18. The heated fluid dispensing system of claim 11 and further comprising:
a second pump actuated by the drive system, wherein the heating system heats material fed to an inlet of the second pump; and
a second heated hose connecting an outlet of the second pump to the gun, wherein the gun mixes materials from outlets of the first and second pumps, the second heated hose comprising:
an inner core;
a metallic-coated conductor wrapped around the inner core; and
an outer sheath surrounding the metallic-coated conductor and the inner core.

19. An electrically heated hose comprising:
a flexible inner hose;
a conductor wrapped around the flexible inner hose, the conductor comprising:
a wire core; and
a conductive coating surrounding the wire core;
a jacket surrounding the conductor and the flexible inner hose.

20. The electrically heated hose of claim 19 wherein the conductive coating is non-reactive.

21. The electrically heated hose of claim 20 wherein the conductive coating is resistant to water corrosion.

22. The electrically heated hose of claim 21 wherein the conductive coating is metallic.

23. The electrically heated hose of claim 19 wherein jacket is moisture impermeable.
